(19) United States
(12) Patent Application Publication
(10) Pub. No.: US 2014/0376388 A1
(43) Pub. Date: Dec. 25, 2014

(54) SYSTEM FOR MONITORING CABLES CONNECTIONS USING A TIME DOMAIN REFLECTOMETER AND A NETWORK DEVICE

(71) Applicant: Boris A. Khozyainov, Korolev (RU)

(72) Inventor: Boris A. Khozyainov, Korolev (RU)

(73) Assignee: Boris Alekseevich Khozyainov, Korolev (RU)

(21) Appl. No.: 14/344,700

(22) PCT Filed: Sep. 13, 2012
(86) PCT No.: PCT/RU2012/000759

§ 371 Date: Sep. 11, 2014

(30) Foreign Application Priority Data
Sep. 14, 2011 (RU) 2011137661

(51) Int. Cl. H04L 12/26; G01B 9/02

(52) U.S. Cl. CPC H04L 43/0811; G01B 9/0209
USPC 370/248

(57) ABSTRACT

The invention relates to communication technology. Use of the invention allows a system to monitor cable connections without establishing a network connection using a built-in time domain reflectometer of a network device. This technical result is achieved by steps of: a port of patch panel is provided with a sensor which perceives a signal of time domain reflectometer, using the time domain reflectometer the system measures length of the cable connected to a port of said network device, comparing time of said sensor actuation and time of the measurement the system determines the port of patch panel to which the port of network device is connected.

### FIELD OF THE INVENTION

The invention is intended mainly to the communication technology and can be used for monitoring connections of patch panels.

### BACKGROUND OF THE INVENTION

There are many different means for cable systems monitoring in the world. The main purpose of the systems is to understand how cables connect devices.

For example, in the US Patent Application US2006/0164998 TDR (Time Domain Reflectometer) uses to analyze connections which appear in a cable channel.

The patent RU2313800 describes the system with sensors attached to a patch panel. The sensors change their state when a connection is established between network devices. The system identifies the port of the path panel where a network device is connected to. The identification is based on comparison of a sensor event and changing status of a network device port. The disadvantage of the system is impossibility to identify cables connection before establishment a network connection.

### SUMMARY OF THE INVENTION

Thus, the object of the present invention consists in developing such means of monitoring cable connections that allow to identify the patch panel port to which a network device is connected without establishment a connection between network devices.

In order for achieving this technical result, it is proposed a system for monitoring cable connections using time domain reflectometer, which system comprising a network device comprising ports for network connection in which device at least several of the ports are connected to an apparatus which measures length of a cable that is connected to a port; a patch panel comprising ports and each of at least some ports of the patch panel provided with a sensor of time domain reflectometer signal which sensor changes its output signal when a signal of time domain refractometer is transmitted through a port which corresponds to the sensor; a management computer system which identifies a port of the patch panel to which a port of the network device is connected comparing time of change of signal from said apparatus and time of change of signal of said sensor.

The patch panel can comprise a sensor of connection which sensor changes output signal when network devices transmit data through the patch panel port which port corresponds to said sensor of connection. The sensor of connection can perceives electromagnet radiation which radiation appears as a side effect when data signals is transmitted. Or the sensor can have an electrical connection to said corresponding port of patch panel.

In a similar the sensor of time domain reflectometer signal can perceive electromagnetic radiation from a time domain reflectometer or can have an electrical connection to a corresponding port of patch panel.

Additionally when sensor of connection are used the management computer system identifies the port of the patch panel to which a port of the network device is connected comparing time of change of signal of data transmitted between network devices and time of change of signal of said sensor of connection.

The network devices can transmit a signal of said apparatus in some time interval and does not transmit a signal of said apparatus through its port when said port transmits data.

In some cases the network devices transmits to the management computer system information which comprises at least a port identifier when length of the cable channel which is connected to the port with said identifier changes.

To achieve full control over connections the network devices transmits a signal of said apparatus in some time interval through each of its ports which port are not used for data transmission and have a connection to said apparatus.

It is convenient in some cases that the management computer system determines that the cable which is connected to a port of said network device is not connected to a port of said patch panel using length of said cable which length is transmitted by the network devices.

Moreover the sensor of connection and the sensor of time domain reflectometer signal can comprise shared elements of their construction.

Additionally the present invention describes a network device comprising ports for connecting other network devices which network device comprising at least one apparatus which measures length of a cable that is connected to a port. The network device transmits a signal of the apparatus in some time interval through each of its ports which port is not used for data transmission and has a connection to said apparatus.

This network device can transmit automatically through one of its ports information which comprises at least a port identifier when length of the cable which is connected to the port with said identifier changes.

For convenience of a user the network can set mode of light indication of its port according command of the user.

### BRIEF DESCRIPTION OF THE DRAWINGS

FIG. 1 shows the general block diagram of the system for monitoring cable connections.

### DETAILED DESCRIPTION OF THE INVENTION

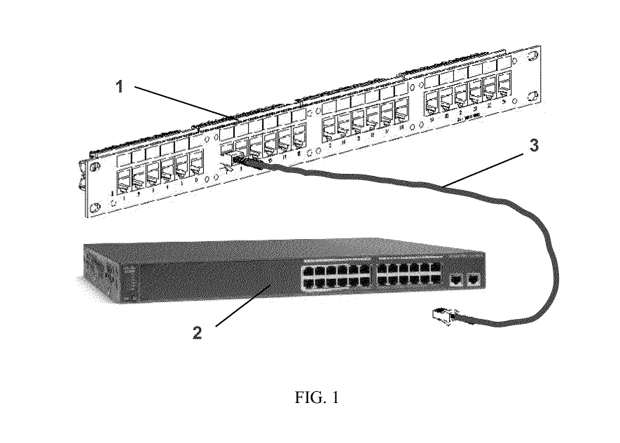

The system according to the present invention can be implemented in several similar embodiments that are, nevertheless, implemented in the same way that is presented in FIG. 1. Ports of the patch panel 1 are provided by sensors of connection to detect two types of signals. The first type is described in the patent RU74536. It serves to determine presence of electromagnetic radiation which appears near a patch panel port as a side effect when data signals is transmitted between the network device 2 (a 100-Base-T switch in this case) and another network device (a personal computer for example) that is connected by a cable to the port at the rear side of the patch panel. In another case the sensor of connection can have an direct electrical connection to the cable channel. If the sensor have large input resistance its influence to data signals is insignificant.

The patent RU2313800 describes when the electrical connection (using the patch cord 3) between the personal computer and the network switch takes place the data is transmitted at ones. Because in case of absence user data the signal “Idle” is transmitted. At the same time the network switch transmit over a network to a management computer system information about change of state of the switch port (using standard ways: SNMP-traps, log files or MAC-addresses table). Said management computer system generally is a network computer with a proper software. The system compare the time of network connection establishment and time of the sensor actuation. It allows the system to determine what port of the patch panel 1 the plug of the patch cord 3 is connected to.

However said approach does not work if said personal computer is not connected to the network. The present invitation is used to solve this problem. Many of modern network switch (e.g Cisco 2960 series) have a built-in TDR (Time Domain Reflectometer) which allows to measure total length of the cable channel that is connected to a switch port. If the length is zero then no cable is connected.

To date a user of network switch starts of TDR function but it is not automatic. To monitor cable connections continuously needs to measure cable length periodically (e..g. every half of second) . In this case a 24-ports network switch is scanned for 12 seconds. For continuous scanning the TDR command can be started from an administrator PC in a loop. However a better way is to use a small software application which is controlled by the operating system of a switch. The results can be transmitted to the management computer system in form of SNMP traps , SNMP inform messages, log files records or TCP data with specific port number. On order to reduce network traffic information about measurement results can be transmitted if length of a cable channel is changed. If a network connection is established there is no need to measure cable length. The information about switch port state is available from the operating system. Apparently the value of cable length in a switch port can be used to find that the port is occupied as well as that the patch cord 3 is not connected to the patch panel 1 at all.

Functions of connection sensor and sensor of TDR signal can be performed by the same physical unit. For example it can be an inductance coil with a JFET transistor connected to an ADC and then to a microprocessor (MCU). The MCU can detect a sensor signal using data form the ADC.

A network switch is a special-purpose computer. It is not difficult to blink a LED indicator of switch port in the manner which needs to a user. It can be useful to mark the port to connect the patch cord 3.

1. System for monitoring cable connections using time domain reflectometer, which system comprising:
a network device comprising ports for network connection in which device at least several of said ports are connected to an apparatus which measures length of a cable that is connected to a port;
a patch panel comprising ports and each of at least some ports of said patch panel is provided with a sensor of time domain reflectometer signal which sensor changes its output signal when a signal of time domain refractometer is transmitted through a port which corresponds to said sensor;
a management computer system which identifies a port of said patch panel to which a port of said network device is connected comparing time of change of signal from said apparatus and time of change of signal of said sensor .

2. The system according to claim 1, characterized in that said patch panel comprises a sensor of connection which sensor changes output signal when network devices transmit data through the patch panel port which port corresponds to said sensor of connection.

3. The system according to claim 2, characterized in that said sensor of connection perceives electromagnet radiation which radiation appears as a side effect when data signals is transmitted.

4. The system according to claim 2, characterized in that said sensor of connection has an electrical connection to said corresponding port of patch panel.

5. The system according to claim 1, characterized in that said sensor of time domain reflectometer signal perceives electromagnetic radiation which radiation appears as a side effect when a signal of said apparatus is transmitted.

6. The system according to claim 1, characterized in that said sensor of time domain reflectometer signal has an electrical connection to said corresponding port of patch panel.

7. The system according to claim 2, characterized in that said management computer system identifies the port of said patch panel to which a port of said network device is connected comparing time of change of signal of data transmitted between network devices and time of change of signal of said sensor of connection.

8. The system according to claim 1, characterized in that said network devices transmits a signal of said apparatus in some time interval.

9. The system according to claim 1, characterized in that said network devices does not transmit a signal of said apparatus through its port when said port transmits data.

10. The system according to claim 1, characterized in that said network devices transmits to said management computer system information which comprises at least a port identifier when length of the cable which is connected to the port with said identifier changes.

11. The system according to claim 1, characterized in that said network devices transmits a signal of said apparatus in some time interval through each of its ports which port are not used for data transmission and have a connection to said apparatus.

12. The system according to claim 1, characterized in that said management computer system determines that the cable which is connected to a port of said network device is not connected to a port of said patch panel using length of said cable which length is transmitted by said network devices.

13. The system according to claim 2, characterized in that said sensor of connection and said sensor of time domain reflectometer signal comprise shared elements of their construction.

14. Network device comprising ports for connecting other network devices which network device comprising:
at least one apparatus which measures length of a cable that is connected to a port;
characterized in that:
transmits a signal of said apparatus in some time interval through each of its ports which port does not use for data transmission and has a connection to said apparatus.

15. The network device according to claim 14, characterized in that transmits automatically through one of its ports information which comprises at least a port identifier when length of the cable which is connected to the port with said identifier changes.

16. The network device according to claim 14, characterized in that can set mode of light indication of its port according command of a user.
